(19) United States
(12) Patent Application Publication
(10) Pub. No.: US 2019/0116119 A1
(43) Pub. Date: Apr. 18, 2019

(54) INTER-VRF ROUTING USING NORMAL NETWORK OPERATION MODEL

(71) Applicants: Xingjun CHU, Ottawa (CA); Guoli YIN, Ottawa (CA)

(72) Inventors: Xingjun CHU, Ottawa (CA); Guoli YIN, Ottawa (CA)

(73) Assignee: Huawei Technologies Co., Ltd., Shenzhen (CN)

(21) Appl. No.: 15/785,759

(22) Filed: Oct. 17, 2017

(51) Int. Cl. H04L 12/741; H04L 12/713

(52) U.S. Cl. CPC H04L 45/74; H04L 45/586

(57) ABSTRACT

A method of routing a packet from a source associated with a first VRF function instantiated on a device to a destination associated with a second VRF function instantiated on the device. The method comprises creating a logical link between a first logical interface on the first VRF function and a second logical interface on the second VRF function. The packet is routed from the source along the first VRF function to the first logical interface. The packet is transferred from the first logical interface to the second logical interface along the logical link. The packet is transferred from the second logical interface along the second VRF function to the destination. The first VRF function can be the same as the second VRF function.

### RELATED APPLICATIONS

Not Applicable.

### TECHNICAL FIELD

The present disclosure relates to the field of communications networks, and particular examples or aspects relate to routing packets from a source associated with a first VRF function to a destination associated with a second VRF function, where the first and second VRF functions are collocated on a physical device.

### BACKGROUND

Virtual routing and forwarding (VRF) is a technology in IP-based computer networks 74 (FIG. 1) that allows multiple routing tables to co-exist simultaneously within a physical (router) device.

FIG. 3 shows an example, in the data plane, of a physical router 300, which may, in some examples, be an electronic device (ED) 52 (FIG. 1), on which is instantiated two VRF functions, denoted VRF-A 310 and VRF-B 320. By way of non-limiting example, the router 300 has four OSI layer 2 (L2) or Physical interfaces denoted as 301-304 respectively. Each physical interface 301-304 has a name. Such names follow a naming convention. In the example shown, the naming convention (“XXGE/c/s/p.vlan”) adopted identifies the bit rate supported “XXGE” (“10GE” represents 10 Gb), the chassis “c”, slot “s”, port “p” and the VLAN identifier “.vlan”.

In the example shown, two of the physical interfaces 301, 302 are associated with corresponding logical interfaces 311, 312 of VRF-A 310 and two of the physical interfaces 303, 304 are associated with corresponding logical interfaces 323, 324 of VRF-B 320. An IP address is assigned to each logical interface 311, 312, 323, 324.

Because the routing table instances within a VRF function are independent, IP addresses in one instance may be re-used or overlap with those of another instance without conflict. Thus, while the IP addresses assigned to each logical interface 311, 312, 323, 324 are shown in the figure as being different, it is conceivable that a logical interface on one VRF function (by way of non-limiting example, logical interface 311 of VRF-A 310) may have assigned to it, the same IP address as a logical interface on another VRF function (by way of non-limiting example, logical interface 323 of VRF-B 320.

This permits improved network functionality at the OSI layer 3 (L3) or Network level since network paths can be isolated without using multiple physically disparate network routers. Rather, a single physical device 300 may be shared by such instances, which may correspond to different virtualized networks, different virtual private networks (VPNs) and/or multi-user groups.

In some cases, however, there are scenarios where it is desirable to by-pass the isolation provided by multiple VRF functions collocated on a single physical device 300. By way of non-limiting example, a source device (not shown, but which may be an ED 52) on a network 74 associated with a first VRF function (such as VRF-A 310) tries to transmit packets to a destination device (not shown, but which may be an ED 52) on a network 74 associated with a second VRF function (such as VRF-B 320). In such scenarios, the IP address space of the first VRF function will not overlap the IP address space of the second VRF function.

One mechanism typically employed to by-pass the isolation is by route leaking via border gateway protocol (BGP) route target (RT) import and export. An example of such mechanism is shown in FIG. 4. When BGP is configured, it is instructed to run within each of VRF-A 310 and VRF-B 320 and is used to leak the routes between VRF-A 310 and VRF-B 320. The RT command of BGP is employed to export an RT (denoted 1:1) from VRF-A 310 and import the same RT into VRF-B 320. Similarly, an RT (denoted 2:2) is exported from VRF-B 320 and imported into VRF-A 310.

Thus, when a source ED 52 along the network 74 associated with VRF-A 310 tries to transmit packets to a destination ED 52 along the network 74 associated with VRF-B 320, the packets get routed along VRF-A 310 and exported from VRF-A 310 with a RT of 1:1. Because VRF-B 320 is now configured to import packets with a RT of 1:1, it imports the exported packets into VRF-B 320 and delivers them to the destination ED 52 along the network 74 associated with VRF-B 320.

Similarly, when a source ED 52 along the network 74 associated with VRF-B 320 tries to transmit packets to a destination ED 52 along the network 74 associated with VRF-A 310, the packets get routed along VRF-B 320 and exported from VRF-B 320 with a RT of 2:2. Because VRF-A 310 is now configured to import packets with a RT of 2:2, it imports the exported packets into VRF-A 310 and delivers them to the destination ED 52 along the network 74 associated with VRF-A 310.

However, such a mechanism is at odds with conventions established for use in connection with the common network operation model since there are no explicit connection and aggregation points between VRF-A 310 and VRF-B 320. This lack of explicit connection means that conventional network operation, administration and maintenance (OAM) tools that operate on and/or with interfaces and/or links are not supported.

Accordingly, there may be a need for routing packets from a source associated with a first VRF function to a destination associated with a second VRF function, where the VRF functions are collocated on a physical ED 52.

This background information is intended to provide information that may be of possible relevance to the present disclosure. No admission is necessarily intended, nor should it be construed, that any of the preceding information constitutes prior art against the present disclosure.

### SUMMARY

It is an object of the present disclosure to obviate or mitigate at least one disadvantage of the prior art.

According to a first aspect, there is disclosed a method of routing a packet, from a source associated with a first VRF function instantiated on a device to a destination associated with a second VRF function instantiated on the device, by encountering a trigger, creating a logical link between a first logical interface on the first VRF function and a second logical interface on the second VRF function, routing the packet from the source along the first VRF function to the first logical interface, transferring the packet from the first logical interface to the second logical interface along the logical link, and routing the packet from the second logical interface along the second VRF function to the destination.

In an embodiment, the action of creating the logical link employs at least one of a memory copy mechanism, a shared memory mechanism, a queuing mechanism, an IPC primitive mechanism and a mechanism available in an operating system employed by the device.

In an embodiment, the logical link is controlled by at least one of a static route, a dynamic routing protocol, a BGP and an IGP.

In an embodiment, the first VRF function can be the same as the second VRF function.

In an embodiment, the method creates a logical interface before creating a logical link. In an embodiment, the logical interface is created by at least one of a loopback interface and another logical interface implementation. In an embodiment, the created logical interface is associated with the first VRF function as the first logical interface. In an embodiment, the first logical interface is created when the first VRF function is instantiated. In an embodiment, the first logical interface is created when there is a packet to be routed beyond the first VRF function. In an embodiment, the created logical interface is associated with the second VRF function as the second logical interface. In an embodiment, the second logical interface is created when the second VRF function is instantiated. In an embodiment, the second logical interface is created when there is a packet to be routed into the second VRF function from beyond another VRF function.

In an embodiment, the action of encountering a trigger comprises determining that the first VRF function and the second VRF function are collocated on the device. In an embodiment, the action of encountering a trigger comprises determining that packets are to be routed between the source associated with the first VRF function and the destination associated with the second VRF function. In an embodiment, the trigger can be generated automatically. In an embodiment, the trigger can be generated automatically. In an embodiment, the trigger can be generated by the device. In an embodiment, the trigger can be generated by an entity external to the device and communicated to the device.

In an embodiment, the method tears down the logical link. In an embodiment, the logical link can be torn down when it is determined that the first VRF function and the second VRF function are no longer collocated on the device. In an embodiment, the logical link can be torn down when it is determined that packets are no longer to be routed between the source associated with the first VRF function and the destination associated with the second VRF function. In an embodiment, the logical link can be torn down automatically. In an embodiment, the logical link can be torn down manually.

According to a second aspect, there is disclosed a network function comprising a network interface, a processor and a non-transient memory. The network interface receives data from and transmits data to network functions connected to a network. The non-transient memory stores instructions that when executed by the processor, cause the network function to be configured to encounter a trigger, create a logical link between a first logical interface on a first VRF function instantiated on the network function and second logical interface on a second VRF function instantiated on the network function, route a packet from a source along the first VRF function along the first VRF function to the first logical interface, transfer the packet from the first logical interface to the second logical interface along the logical link, and route the packet from the second logical interface along the second VRF function to a destination along the second VRF function.

Embodiments have been described above in conjunction with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Some aspects and embodiments of the present disclosure may provide routing of a packet associated with a first VRF function to a destination associated with a second VRF function instantiated on a common device in a manner consistent with a common network operational model.

### BRIEF DESCRIPTION OF THE FIGURES

Further features and advantages of the present disclosure will become apparent from the following detailed description, taken in combination with the appended drawings, in which:

FIG. 1 is a block diagram of an ED, within a computing and communications environment that may be used for implementing devices and methods in accordance with representative examples;

FIG. 2 is a flowchart illustrating a method for routing packets from a source associated with a first VRF function to a destination associated with a second VRF function instantiated on a common device according to an example;

FIG. 3 is a block diagram in the data plane of a device showing a plurality of VRF functions instantiated thereon;

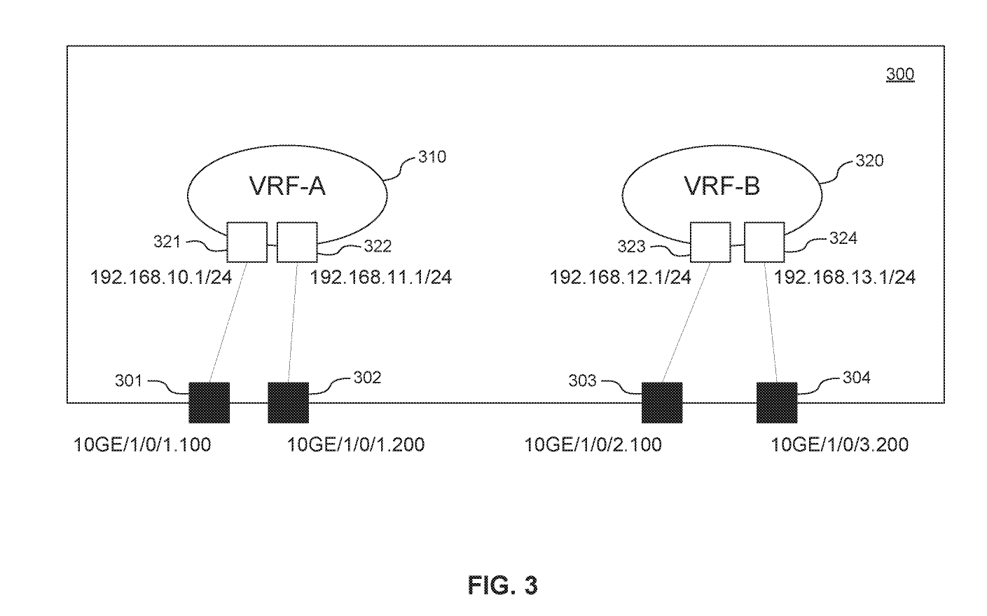

FIG. 4 shows the block diagram of FIG. 3 when the VRF functions are configured for route leaking across the VRF functions using the BGP RT import and export command set;

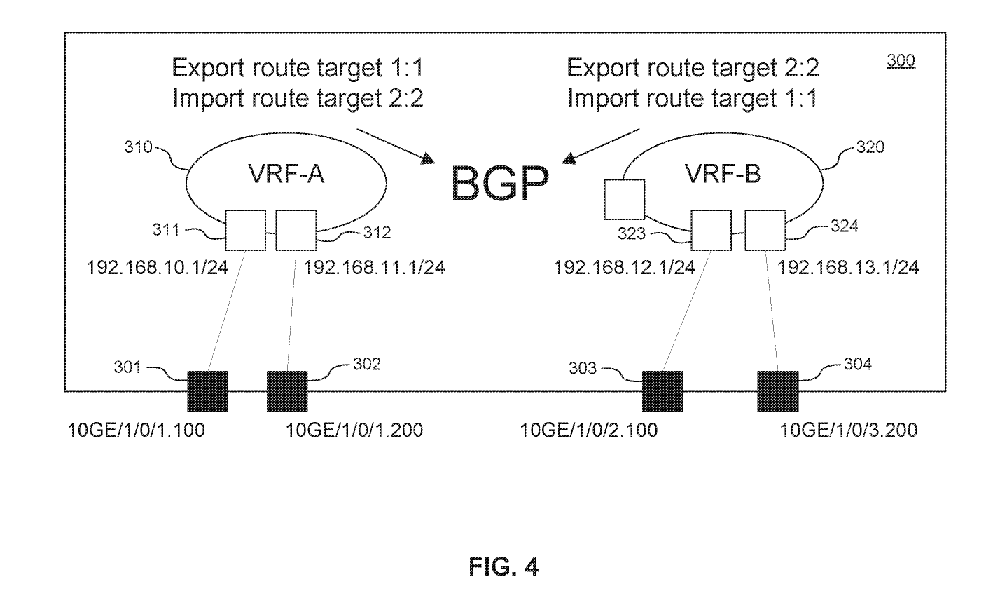

FIG. 5 shows the block diagram of FIG. 3 when the device is configured to perform routing from a source associated with a first VRF function instantiated thereon to a destination associated with a second VRF function instantiated thereon according to an example;

FIG. 6 shows the block diagram of FIG. 5 in the control plane;

FIG. 7 shows an example use case for routing packet from a switch fabric beyond the device and back into the same fabric according to an example; and

FIG. 8 shows a block diagram in the user plane of an ED where a VRF function instantiated thereon is configured to route a packet beyond the VRF function and back into the same VRF function in support of the use case of FIG. 7.

For purposes of explanation and not limitation, specific details are set forth in order to provide a thorough understanding. In some instances, detailed descriptions of well-known devices, circuits and methods are omitted so as not to obscure the description with unnecessary detail.

### DESCRIPTION

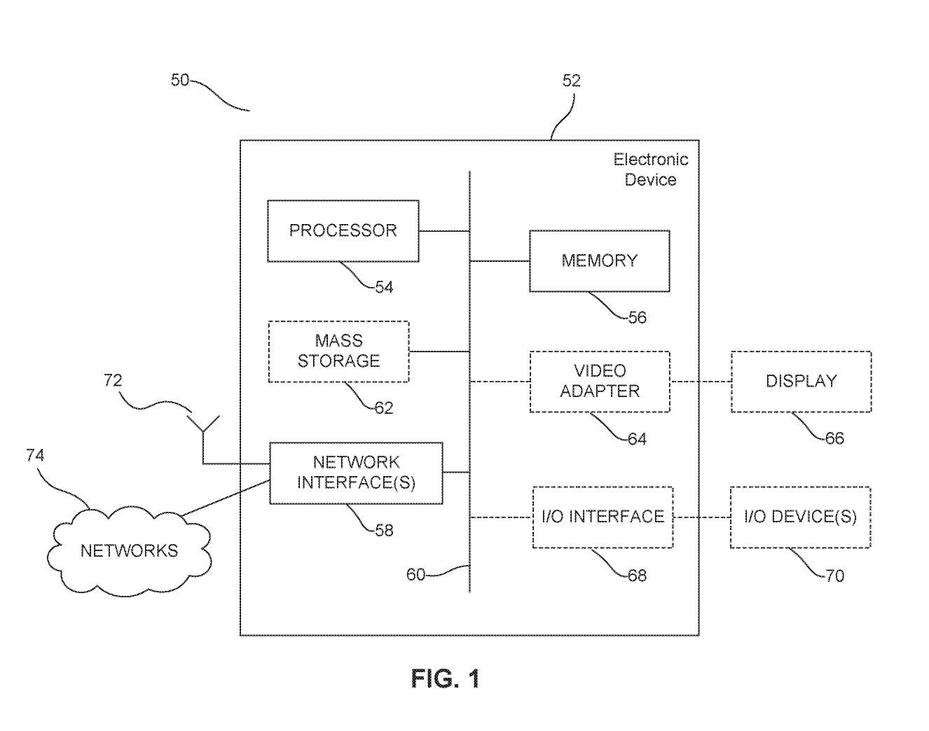

FIG. 1 is a block diagram of an ED 52 illustrated within a computing and communications environment 50 that may be used for implementing the devices and methods disclosed herein. In some embodiments, the ED 52 may be an element of communications network infrastructure, such as a base station (for example a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other examples, the ED 52 may be a device that connects to the network infrastructure over a radio interface, such as a mobile phone, smart phone or other such device that may be classified as a User Equipment (UE). In some embodiments, ED 52 may be a Machine Type Communications (MTC) device (also referred to as a machine-to-machine (m2m) device), or another such device that may be categorized as a UE despite not providing a direct service to a user. In some references, an ED 52 may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, etc. The ED 52 typically includes a processor 54, such as a Central Processing Unit (CPU), and may further include specialized processors such as a Graphics Processing Unit (GPU) or other such processor, a memory 56, a network interface 58 and a bus 60 to connect the components of ED 52. ED 52 may optionally also include components such as a mass storage device 62, a video adapter 64, and an I/O interface 68 (shown in dashed lines).

The memory 56 may comprise any type of non-transitory system memory, readable by the processor 54, such as static random access memory (SRAM), dynamic random access memory (DRAM), synchronous DRAM (SDRAM), read-only memory (ROM), or a combination thereof. In an example, the memory 56 may include more than one type of memory, such as ROM for use at boot-up, and DRAM for program and data storage for use while executing programs. The bus 60 may be one or more of any type of several bus architectures including a memory bus or memory controller, a peripheral bus, or a video bus.

The ED 52 may also include one or more network interfaces 58, which may include at least one of a wired network interface and a wireless network interface. As illustrated in FIG. 1, network interface 58 may include a wired network interface to connect to a network 74, and also may include a radio access network interface 72 for connecting to other devices over a radio link. When ED 52 is a network infrastructure element, the radio access network interface 72 may be omitted for nodes or functions acting as elements of the PLMN other than those at the radio edge (e.g. an eNB). When ED 52 is infrastructure at the radio edge of a network 74, both wired and wireless network interfaces may be included. When ED 52 is a wirelessly connected device, such as a UE, radio access network interface 72 may be present and it may be supplemented by other wireless interfaces such as WiFi network interfaces. The network interfaces 58 allow the ED 52 to communicate with remote entities such as those connected to network 74.

The mass storage 62 may comprise any type of non-transitory storage device configured to store data, programs, and other information and to make the data, programs, and other information accessible via the bus 60. The mass storage 62 may comprise, for example, one or more of a solid state drive, hard disk drive, a magnetic disk drive, or an optical disk drive. In some embodiments, mass storage 62 may be remote to the ED 52 and accessible through use of a network interface such as interface 58. In the illustrated example, mass storage 62 is distinct from memory 56 where it is included, and may generally perform storage tasks compatible with higher latency, but may generally provide lesser or no volatility. In some embodiments, mass storage 62 may be integrated with a heterogeneous memory 56.

The optional video adapter 64 and the I/O interface 68 (shown in dashed lines) provide interfaces to couple the ED 52 to external input and output devices. Examples of input and output devices include a display 66 coupled to the video adapter 64 and an I/O device 70 such as a touch-screen coupled to the I/O interface 68. Other devices may be coupled to the ED 52, and additional or fewer interfaces may be utilized. For example, a serial interface such as Universal Serial Bus (USB) (not shown) may be used to provide an interface for an external device. Those skilled in the art will appreciate that in examples in which ED 52 is part of a data center, I/O interface 68 and Video Adapter 64 may be virtualized and provided through network interface 58.

In some examples, ED 52 may be a standalone device, while in other examples ED 52 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network 74) can be divided between different sub-networks, in some cases in the form of a resource slice. If the resources across a number of connected data centers or other collection of nodes are sliced, different network slices can be created.

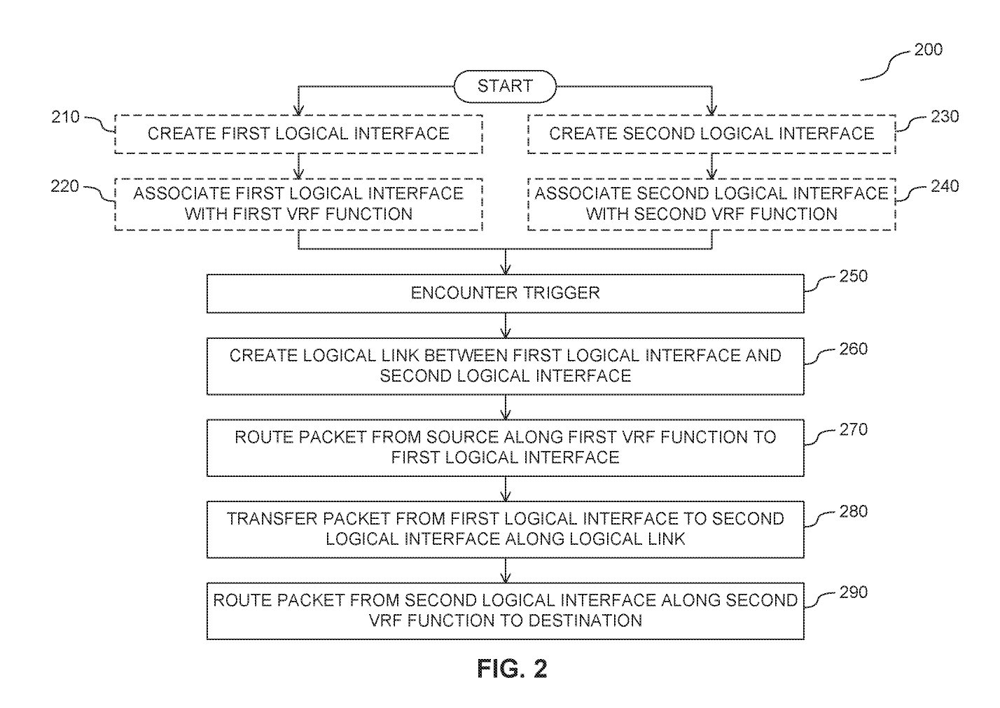

Turning now to FIG. 2, there is shown a flow chart, shown generally at 200, showing example actions taken in a method for routing a packet from a source associated with a first VRF function instantiated on a device 300 to a destination associated with a second VRF function instantiated on the device 300.

One example action 210 may be to create a first logical interface.

One example action 220 may be to associate the first logical interface with the first VRF function.

One example action 230 may be to create a second logical interface.

One example action 240 may be to associate to the second logical interface with the second VRF function.

One example action 250 is to encounter a trigger.

One example action 260 is to create a logical link between the first logical interface and the second logical interface.

One example action 270 is to route the packet from the source along the first VRF function to the first logical interface.

One example action 280 is to transfer the packet from the first logical interface to the second logical interface along a logical link.

One example action 290 is to route the packet from the second logical interface along the second VRF function to the destination.

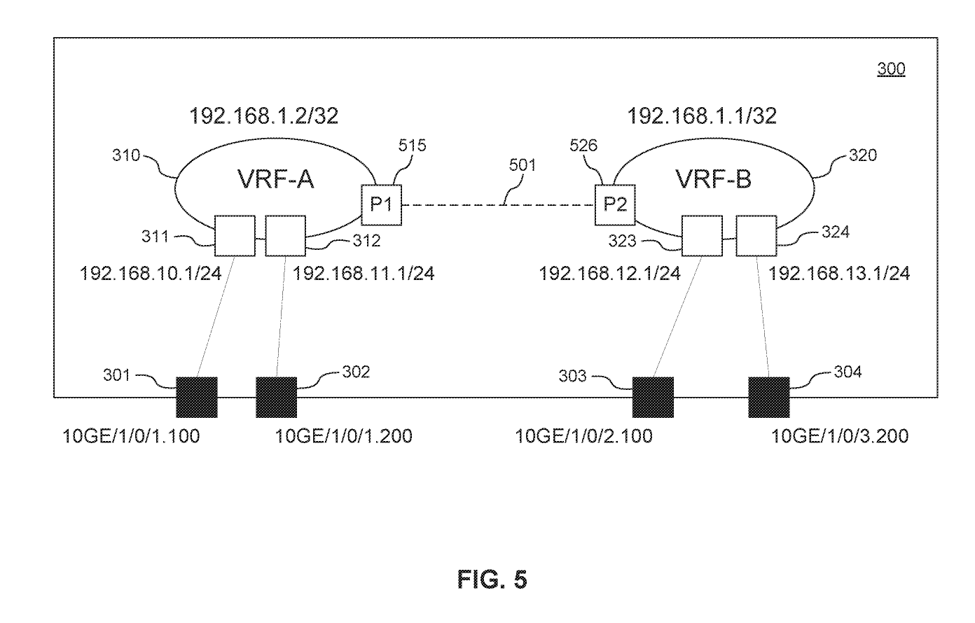

Turning now to FIG. 5, there is shown an example in the data plane, of routing packets from a source associated with a first VRF function instantiated on a device 300 to a destination associated with a second VRF function instantiated on the device 300, in a manner that conforms to existing conventions established for use with the common network operation model.

In some examples, the mechanism may be triggered automatically when either or both of a first VRF and a second VRF, which were heretofore located on physically different devices 300, are collocated on a common physical device 300. In such event, the possibility exists that packets may be routed between a source associated with the first VRF function to a destination associated with the second VRF function.

In some examples, the mechanism may be triggered when the first and second VRFs are collocated on the common device 300. In some examples, the mechanism may be triggered only when it is desired to route packets between the source associated with the first VRF function to the destination associated with the second VRF function.

In either case, the mechanism could be triggered by the device 300 or by an entity external to the device 300 and communicated to the device 300 along a network interface 58 when conditions dictating the triggering of the mechanism are satisfied. In some examples, the mechanism could be triggered using a pre-defined Application Programming Interface (API).

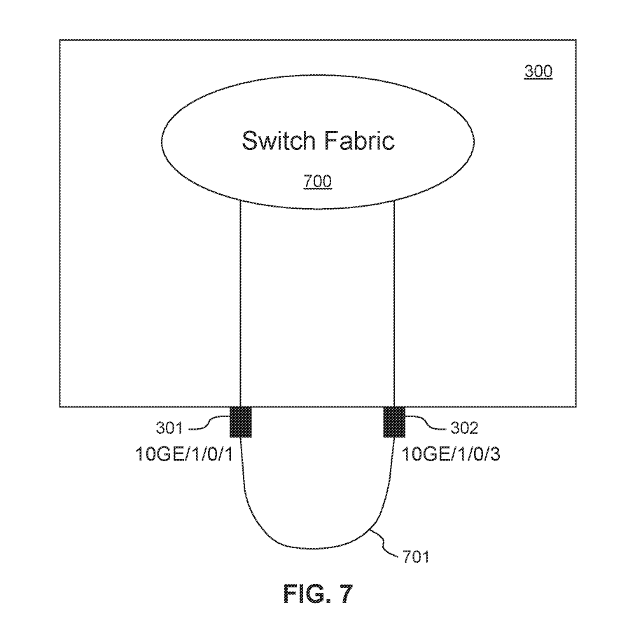

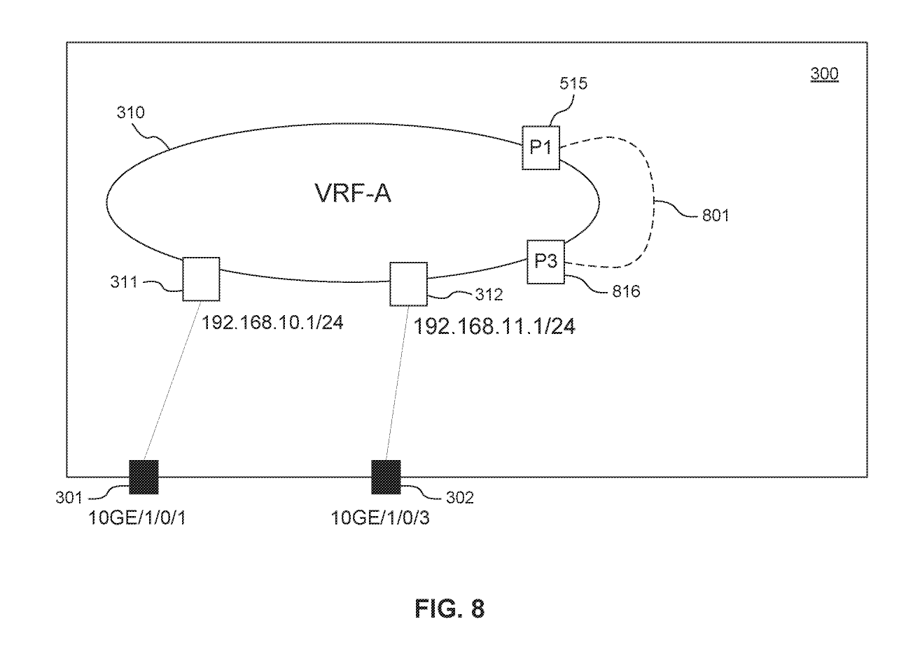

In some examples, the mechanism may be triggered manually by an operator using an administrative interface for such operator, which may comprise the optional video adapter 64 and/or the I/O interface 68 (whether or not virtualized and/or provided through network interface 58) and internal and/or external input and/or output devices coupled thereto. In such examples, the operator may determine to trigger the mechanism when the first VRF function and the second VRF function are already collocated on the device 300 and it is determined that packets are to be routed from a source associated with the first VRF function to a destination associated with the second VRF function. By way of non-limiting example, such a scenario could arise in the context of the situation described below in respect of FIGS. 7 and 8.

However initiated, when the trigger is encountered, a first logical interface P1 515 is created and added into or otherwise associated with a VRF function (by way of non-limiting example, VRF-A 310) and provided an IP address.

Similarly, a second logical interface P2 526 is created and added into a VRF function (by way of non-limiting example, VRF-B 320) and provided an IP address.

In some examples, the logical interfaces P1 515, P2 526 could have been created a priori, including at the time of instantiation, or could be created when it is identified that routing between VRF functions is desired.

In some examples, the logical interface P1 515, P2 526 could be associated with a given VRF function 310, 320 at the time that it was created, or it could be unassigned at the time of creation and subsequently associated with a VRF function when it is identified that that inter-VRF routing is desired to and/or from the associated VRF function.

In some examples, one or more logical interfaces could be created and/or assigned for each VRF function to allow for the possibility of facilitating routing between pairs of VRF functions instantiated on a common device 300.

The mechanism by which the logical interface 515, 516 is created can include, without limitation, loopback interface and/or any other logical interface implementation.

Thereafter, when it is desired to perform routing of packets from a source associated with a first VRF function (by way of non-limiting example, VRF-A 310) with which a first logical interface (by way of non-limiting example, P1 515) is associated, beyond the first VRF function and into a second VRF function (by way of non-limiting example, VRF-B 320) with a second logical interface (by way of non-limiting example, P2 526) to a destination device associated with the second VRF function, for example, along a network 74 coupling the destination and VRF-B 320, a logical link 301 is established between P1 315 and P2 326.

The mechanism by which the logical link 501 is created can include, without limitation, memory copy, shared memory, queuing or any inter-process communication (IPC) primitive and/or mechanism available in the operating system employed.

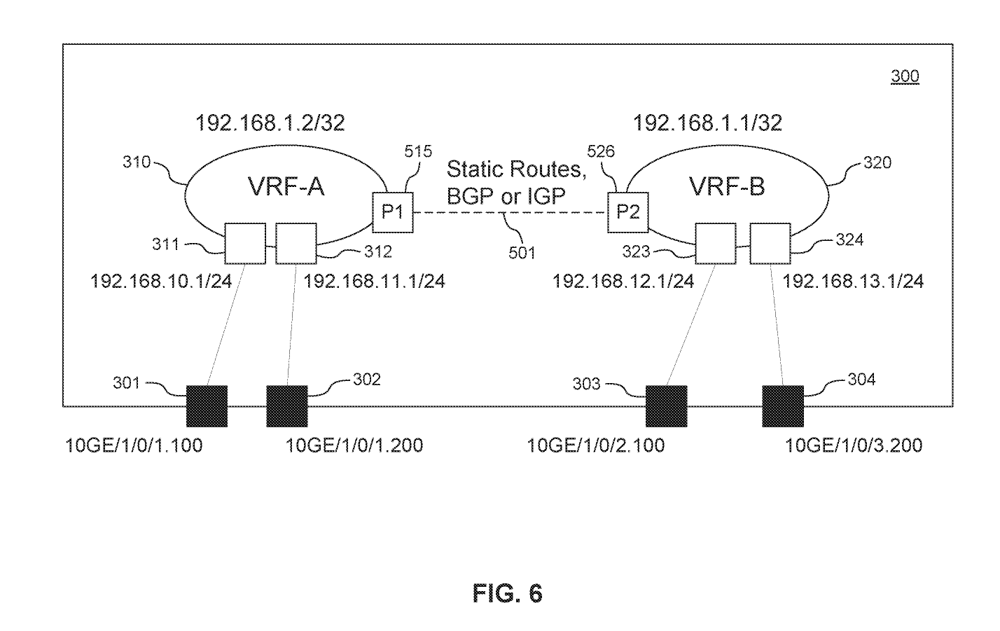

FIG. 6 shows an example, in the control plane, analogous to FIG. 5, and demonstrates that either or both of static routes and/or dynamic routing protocols, including without limitation, BGP and/or interior gateway protocol (IGP) could be employed to control the logical link 301 in the control plane of the VRF functions 310, 320.

Thus, when a source associated with VRF-A 310 tries to transmit packets to a destination device associated with VRF-B 320, the packets are directed in the normal course to logical interface P1 515. The packets received at logical interface P1 515 are transferred, whether (depending upon the underlying mechanism employed to implement the logical link 501, by copying, sharing and/or sending) to logical interface P2 526. When they arrive at logical interface P2 526, the packets are directed in the normal course to the destination device associated with VRF-B 320.

Similarly, when a source device associated with VRF-B 320 tries to transmit packets to a destination device associated with VRF-A 310, the packets are directed in the normal course to logical interface P2 526. Depending upon the underlying mechanism employed to implement the logical link 501, the packets received at logical interface P2 526 are transferred (whether, depending upon the underlying mechanism employed to implement the logical link 501, by copying, sharing and/or sending) to logical interface P1 515. When they arrive at logical interface P1 515, the packets are directed in the normal course to the destination device associated with VRF-A 310.

The mechanism may be torn down by tearing down the logical link.

In some examples, the mechanism may be torn down automatically when there is no longer a desire to route packets between the source associated with the first VRF function to the destination associated with the second VRF function while both the first and second VRF functions remain collocated on the common device 300.

In some examples, the mechanism may be torn down automatically when either or both of the first VRF and the second VRF are no longer collocated on the common device 300.

In either case, the mechanism may be torn down by the device 300 or by an entity external to the device 300 in communication with the device 300 along a network interface 58 when conditions dictating the tear down of the mechanism are satisfied. In some examples, the mechanism could be torn down using a pre-defined API.

In some examples, the mechanism may be torn down manually by an operator using an administrative interface for such operator, which may comprise the optional video adapter 64 and/or the I/O interface 68 (whether or not virtualized and/or provided through network interface 58) and internal and/or external input and/or output devices coupled thereto. In some examples, the operator may determine to tear down the mechanism when it is determined that packets are no longer to be routed from a source associated with the first VRF function to a destination associated with the second VRF function, while both the first and second VRF functions remain collocated on the common device 300.

Thus, it may be understood that the mechanism for routing between VRF functions shown in FIGS. 5 and 6 continues to support conventional network OAM tools that operate one and/or with interfaces and/or links and is compliant with conventions established for use in connection with the common network operation model. As a result, the mechanism disclosed remains easy to understand and operate and facilitates reduction of operational expenses.

Further, the operational model is compatible with common network abstractions including, without limitation, Openstack and/or Neutron. Accordingly, the mapping between such abstractions and the physical network 74 modeled thereby can be easily implemented and supports concepts such as network virtualization and/or automation.

Moreover, common network operations, including without limitation, quality of service (QoS), access control list (ACL), collection of statistics and/or monitoring of traffic between the VRF functions can continue to be performed. Still further, the functionality to support routing between VRF functions disclosed herein may be implemented purely in software as part of the VRF functionality and/or network virtualization upon instantiation on the device 300, which comprise existing and/or legacy hardware and/or technology.

While in some examples the functionality to support routing between VRF functions may be implemented purely in software, in some examples, the functionality may be implemented purely in hardware and/or in a combination of both hardware and software.

While the disclosed routing functionality permits routing between different VRF functions 110, 120 instantiated on a common device 300 as described above, such functionality could be employed between logical interfaces associated with a single common VRF function. An example use case, shown in FIG. 7, for such scenario may include routing one or more packets beyond a physical switch fabric 700 and back into the same fabric 700 in order to overcome a hardware limitation inherent to the fabric 700. By way of non-limiting example, in an L2/L3 routing switch hybrid mode, it is conceivable that the data plane pipeline does not handle one or more packets in a first process, such that it would send the packet out to be returned to the fabric 700 for a second process, such as an L3 forwarding process. During the time when the packet has been routed beyond the fabric, the second process can be switched in.

In FIG. 7, the device 300 has instantiated thereon a single switch fabric 700. The device 300 has two physical interfaces 301, 302. As discussed above, in the example use case, physical interface 301 is physically coupled to physical interface 302 by a physical link 701. Thus, to support the use case, two physical interfaces 301, 302 are devoted to physical link 701 and not available for other purposes.

FIG. 8 shows an example, in the data plane, of routing beyond and back into a VRF function in accordance with the present disclosure. Here, the device 300 has a single VRF function, denoted VRF-A 310, instantiated thereon, in which logical interfaces 311 and 312 are respectively associated with physical interfaces 301 and 302. However, rather than tying up the two physical interfaces 301, 302, logical interface P1 515 is created and added into or otherwise associated with VRF-A 310 and provided an IP address and logical interface P3 816 is also created and added into or otherwise associated with the same VRF-A 310 and provided an IP address. A logical link 801 is established between P1 515 and P3 816.

Thus it may be seen that the routing beyond VRF-A 310 and back into VRF-A 310 may be effected by creating logical interfaces 515, 816 and a logical link 801 coupled therebetween, thus freeing physical interfaces 301, 302 to be available for other purposes.

### General

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

The terms “couple” and “communicate” in any form are intended to mean either a direct connection or indirect connection through some interface, device, intermediate component or connection, whether electrically, mechanically, chemically, or otherwise.

References in the singular form include the plural and vice versa, unless otherwise noted.

As used herein, relational terms, such as “first” and “second”, and numbering devices such as “a”, “b” and the like, may be used solely to distinguish one entity or element from another entity or element, without necessarily requiring or implying any physical or logical relationship or order between such entities or elements.

It should be appreciated that the present disclosure, which is described by the claims and not by the implementation details provided, which can be modified by omitting, adding or replacing elements with equivalent functional elements, provides many applicable inventive concepts that may be embodied in a wide variety of specific contexts. The specific embodiments discussed are merely illustrative of specific ways to make and use the disclosure, and do not limit the scope of the present disclosure. Rather, the general principles set forth herein are considered to be merely illustrative of the scope of the present disclosure.

It will be apparent that various modifications and variations covering alternatives, modifications and equivalents will be apparent to persons having ordinary skill in the relevant art upon reference to this description and may be made to the embodiments disclosed herein, without departing from the present disclosure, as defined by the appended claims.

Accordingly the specification and the embodiments disclosed therein are to be considered examples only, with a true scope of the disclosure being disclosed by the following numbered claims:

What is claimed is:

1. A method of routing a packet, from a source associated with a first virtual routing and forwarding (VRF) function instantiated on a device to a destination associated with a second VRF function instantiated on the device, comprising actions of:
encountering a trigger;
creating a logical link between a first logical interface on the first VRF function and a second logical interface on the second VRF function;
routing the packet from the source along the first VRF function to the first logical interface;
transferring the packet from the first logical interface to the second logical interface along the logical link; and
routing the packet from the second logical interface along the second VRF function to the destination.

2. The method according to claim 1, wherein the action of creating the logical link employs at least one of a memory copy mechanism, a shared memory mechanism, a queuing mechanism, an inter-process communication (IPC) primitive mechanism and a mechanism available in an operating system employed by the device.

3. The method according to claim 1, wherein the logical link is controlled by at least one of a static route, a dynamic routing protocol, a border gateway protocol (BGP), and interior gateway protocol (IGP).

4. The method according to claim 1, wherein the first VRF function is the same as the second VRF function.

5. The method according to claim 1, further comprising an action of, before the action of creating a logical link, creating a logical interface.

6. The method according to claim 5, wherein the logical interface is created by at least one of a loopback interface and another logical interface implementation.

7. The method according to claim 5, further comprising an action of associating the created logical interface with the first VRF function as the first logical interface.

8. The method according to claim 7, wherein the action of creating the first logical interface is performed when the first VRF function is instantiated.

9. The method according to claim 7, wherein the action of creating the first logical interface is performed when there is a packet to be routed beyond the first VRF function.

10. The method according to claim 5, further comprising an action of associating the created logical interface with the second VRF function as the second logical interface.

11. The method according to claim 10, wherein the action of creating the second logical interface is performed when the second VRF function is instantiated.

12. The method according to claim 10, wherein the action of creating the second logical interface is performed when there is a packet to be routed into the second VRF function from beyond another VRF function.

13. The method according to claim 1, wherein the action of encountering a trigger comprises determining that the first VRF function and the second VRF function are collocated on the device.

14. The method according to claim 1, wherein the action of encountering a trigger comprises determining that packets are to be routed between the source associated with the first VRF function and the destination associated with the second VRF function.

15. The method according to claim 1, wherein the trigger is generated automatically.

16. The method according to claim 1, wherein the trigger is generated manually.

17. The method according to claim 1, wherein the trigger is generated by the device.

18. The method according to claim 1, wherein the trigger is generated by an entity external to the device and communicated to the device.

19. The method according to claim 1, further comprising an action of tearing down the logical link.

20. The method according to claim 19, wherein the logical link is torn down when it is determined that the first VRF function and the second VRF function are no longer collocated on the device.

21. The method according to claim 19 wherein the logical link is torn down when it is determined that packets are no longer to be routed between the source associated with the first VRF function and the destination associated with the second VRF function.

22. The method according to claim 19, wherein the logical link is torn down automatically.

23. The method according to claim 1, wherein the logical link is town down manually.

24. A network function comprising:
a network interface for receiving data from and transmitting data to network functions connected to a network;
a processor; and
a non-transient memory for storing instructions that when executed by the processor cause the network function to be configured to:
encounter a trigger;
create a logical link between a first logical interface on a first virtual routing and forwarding (VRF) function instantiated on the network function and a second logical interface on a second VRF function instantiated on the network function;
route a packet from a source along the first VRF function along the first VRF to the first logical interface;
transfer the packet from the first logical interface to the second logical interface along the logical link; and
route the packet from the second logical interface along the second VRF function to a destination along a network along the second VRF function.
